(19) United States
(12) Patent Application Publication
(10) Pub. No.: US 2023/0037152 A1
(43) Pub. Date: Feb. 2, 2023

(54) COMBINED CONVEX HULL OPTIMIZATION

(71) Applicant: Meta Platforms, Inc., Menlo Park, CA (US)

(72) Inventors: Ping-Hao Wu, San Francisco, CA (US); Ioannis Katsavounidis, San Jose, CA (US); Zhijun Lei, Portland, OR (US)

(21) Appl. No.: 17/665,207

(22) Filed: Feb. 4, 2022

Related U.S. Application Data
(60) Provisional application No. 63/227,933, filed on Jul. 30, 2021.

(51) Int. Cl. H04N 19/103; H04N 19/14; H04N 19/30

(52) U.S. Cl. CPC H04N 19/103; H04N 19/14; H04N 19/30

(57) ABSTRACT

The disclosed computer-implemented method may include combining a first video sequence with a second video sequence to generate a combined video sequence. A video complexity of the first video sequence may differ from that of the second video sequence. The method may also include performing, using a baseline encoder, encoding parameter optimization on the combined video sequence to generate a baseline performance curve and performing, using a target encoder, encoding parameter optimization on the combined video sequence to generate a target performance curve. The method may further include analyzing the target encoder by comparing the target performance curve with the baseline performance curve, and generating a bitrate ladder for the target encoder based on the analysis, wherein the bitrate ladder includes desired bitrate-resolution pairs for encoding. Various other methods, systems, and computer-readable media are also disclosed.

### CROSS REFERENCE TO RELATED APPLICATION

This application claims the benefit of U.S. Provisional Application No. 63/227,933, filed 30 Jul. 2021, the disclosure of which is incorporated, in its entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a flow diagram of an exemplary method for combined convex hull optimization.

FIG. 2 is a block diagram of an exemplary system for combined convex hull optimization.

FIG. 3 is a block diagram of an exemplary network for combined convex hull optimization.

FIG. 4 is an example graph illustrating a convex hull for video encoding.

FIG. 5 is an example workflow for convex hull optimization.

FIG. 6 is a graph of bitrate-performance for two different shots.

FIG. 7 is an example workflow for combined convex hull optimization.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The generation, sharing, and consumption of video data has experienced explosive growth in recent years, fueled by the use of portable devices with video encoding and decoding capabilities, new streaming applications that allow for the viewing of video content anywhere and at any time, the widespread adoption of real-time video communication applications, and the continuous growth of broadcast services. As a result, video processing infrastructure may be increasingly strained by the large amount of data to be processed before distribution through communication networks. The resources available on communication networks, mainly in the form of bandwidth, may also be strained given the amount of data that is being shared among users of the networks.

Adaptive streaming (“AS”) has emerged as a key enabler behind the processing and delivery of the increasing amount of shared video data. Adaptive streaming may allow for the adjustment of quality or bitrate of the delivered video bitstream in response to the network conditions and the available bandwidth. In AS, the encoding of a given content may be performed at different resolutions and/or bit rates, with typically five to ten versions of the encoded content made available for use in a streaming session. During a streaming session, a change in the network bandwidth may result in switching to the encoded version of the streamed content that provides the highest quality under the current bandwidth limitations. Although AS may allow for adaptation in response to network conditions, another approach, which may generate encoded versions using the same encoder settings from beginning to end of a long video sequence, may not take into account this key feature of AS and may therefore be suboptimal.

A dynamic optimizer (“DO”) framework may address some of the issues with a suboptimal AS encoding approach. The DO approach may be based on (1) processing of the input content at a finer granularity (e.g., shots), as opposed to the entire input video sequence, and (2) generating different encoded versions of the input content by concatenating shots encoded at different resolutions and rates so that each of the generated bitstreams would correspond to either a pre-specified quality level or bitrate. Shots may refer to segments of the input video content that may have relatively homogeneous properties and that are of durations that may typically last, for example, from 2 to 10 sec.

The generation of different encoded versions of the input content may be performed using a convex hull approach. Shots may first be encoded at different resolutions and bitrates, the convex hull of distortion vs. rate data associated with all such encodings for a given shot may be generated, and points on the convex hull may be used to identify the best rate for a given distortion—or vise-versa—for the shot. Shots that achieve a prespecified quality level or bitrate may then be put together to generate the corresponding bitstream. Multiple bitstreams may be generated using this approach for different quality levels or bitrates.

Even though the DO approach may provide more optimized encodings as compared to the AS approach, the improvements may come at a significant increase in computational complexity of the overall process.

To address this problem, a fast DO approach may include convex hull generation using a relatively fast encoder, whereas the generation of the final bitstreams may be performed using the optimal encoding parameters (e.g., (resolution, bitrate) pairs) from the convex hull generation for each shot and completing the final encodings using the desired high quality but computationally costly encoder.

The present disclosure describes variants of the DO approach. A combined DO approach may include conceptually computing encoder performance for one clip representing the concatenation of all clips in a test set. A variation of the combined DO approach, referred to as the restricted discrete DO approach, may consider a range of quality values in the evaluation that may be reflective of quality values common in AS applications, and may also evaluate the encoder BD-rate performance by considering few points on the convex hull. To reduce the complexity associated with the restricted discrete DO approach, a fast DO approach may be evaluated, where the identification of optimal encoder parameters may be performed based on encodings generated using a fast encoder. The optimal encoder parameters may then be used to generate final encodings using the desired encoder. Convex hull data corresponding to the final encodings may be used to generate the encoder BD-rate performance data.

The present disclosure is generally directed to combined convex hull optimization. As will be explained in greater detail below, embodiments of the present disclosure may combine video sequences of different video complexities, perform encoding parameter optimization on the combined video sequence using a baseline encoder and a target encoder (which in some examples may be a same or similar encoder as the baseline encoder), analyze the target encoder as compared to the baseline encoder from the encoding parameter optimization, and generate a bitrate ladder for the target encoder based on the analysis. The systems and methods described herein may improve the functioning of a computing device itself by reducing computational resources and processing overhead for encoding videos of varying video complexities. The systems and methods described herein may further improve adaptive streaming technology by achieving faster overall encoding times while maintaining a desired level of video quality applicable to a wide variety of video content. In addition, the systems and methods described herein may advantageously achieve a higher average quality for a collection of videos (or a lower average bitrate for the collection of videos). Although offering same or similar video qualities for each video in a collection may provide certain advantages, achieving higher average qualities (e.g., by lowering bitrates in certain videos and increasing bitrates in certain other videos) may be beneficial, for instance, if a large corpus of videos is to be processed.

Features from any of the embodiments described herein may be used in combination with one another in accordance with the general principles described herein. These and other embodiments, features, and advantages will be more fully understood upon reading the following detailed description in conjunction with the accompanying drawings and claims.

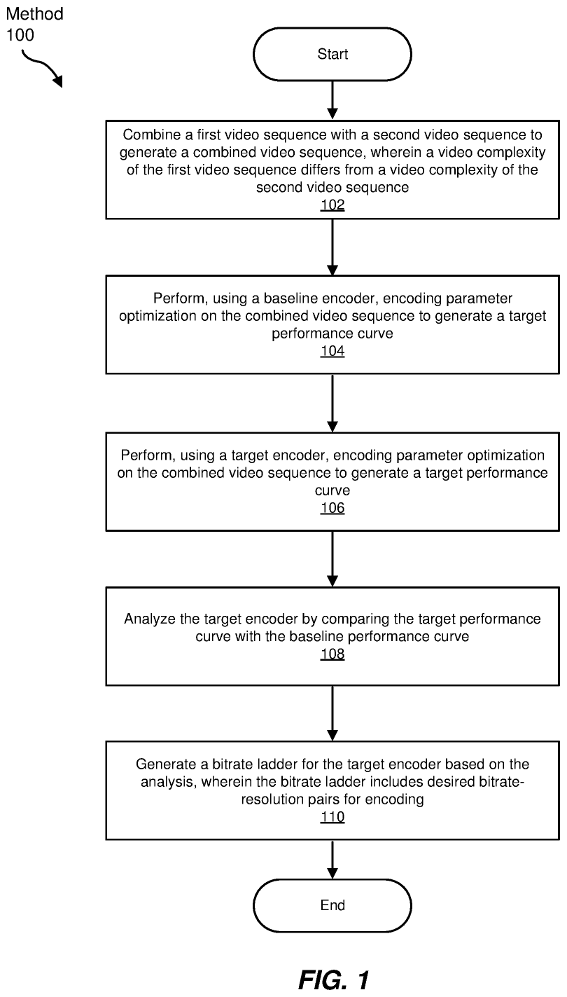

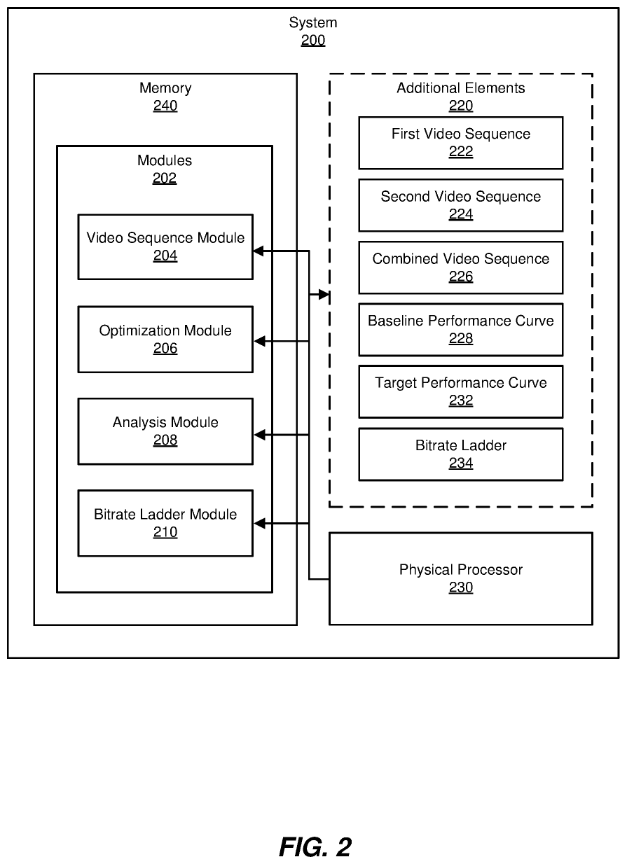

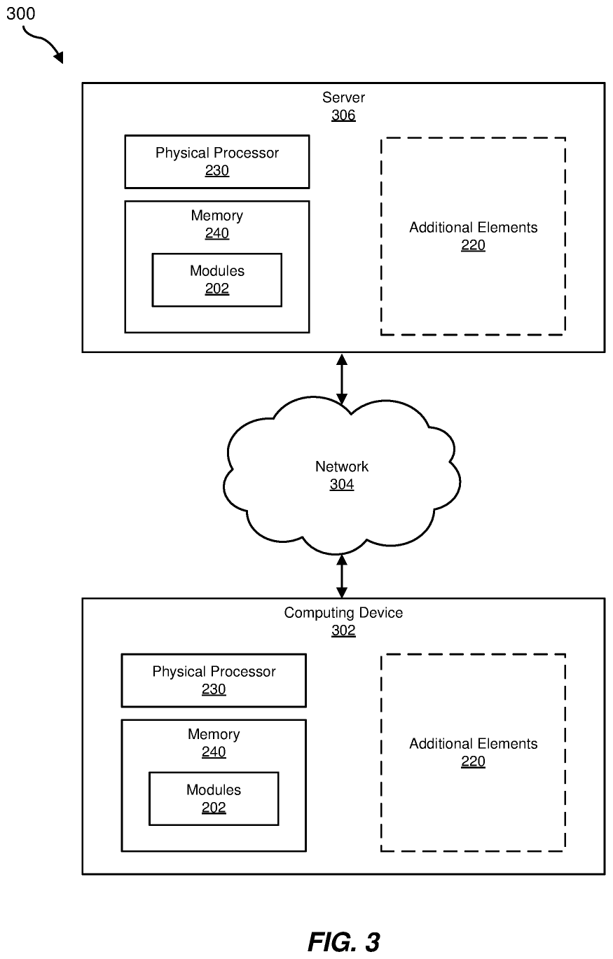

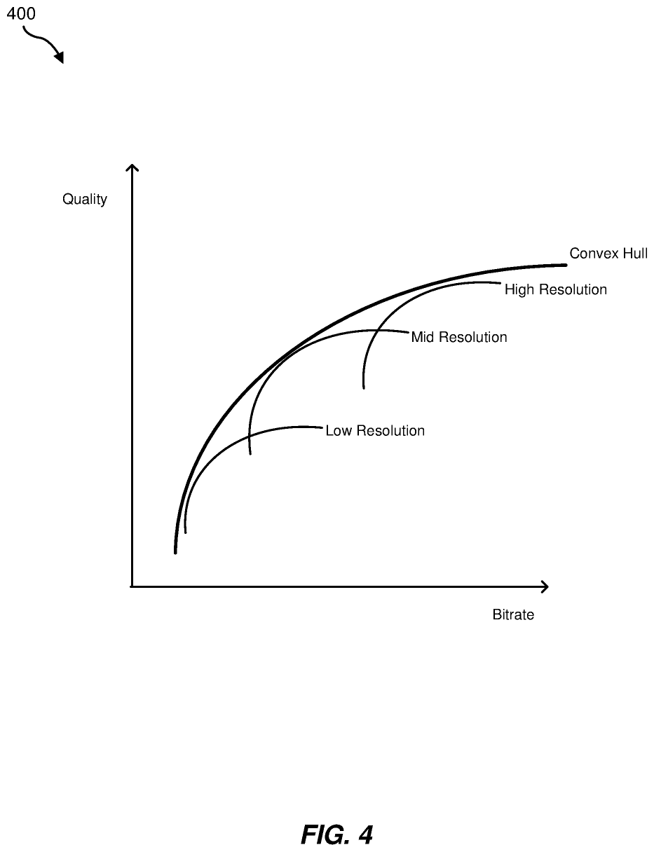

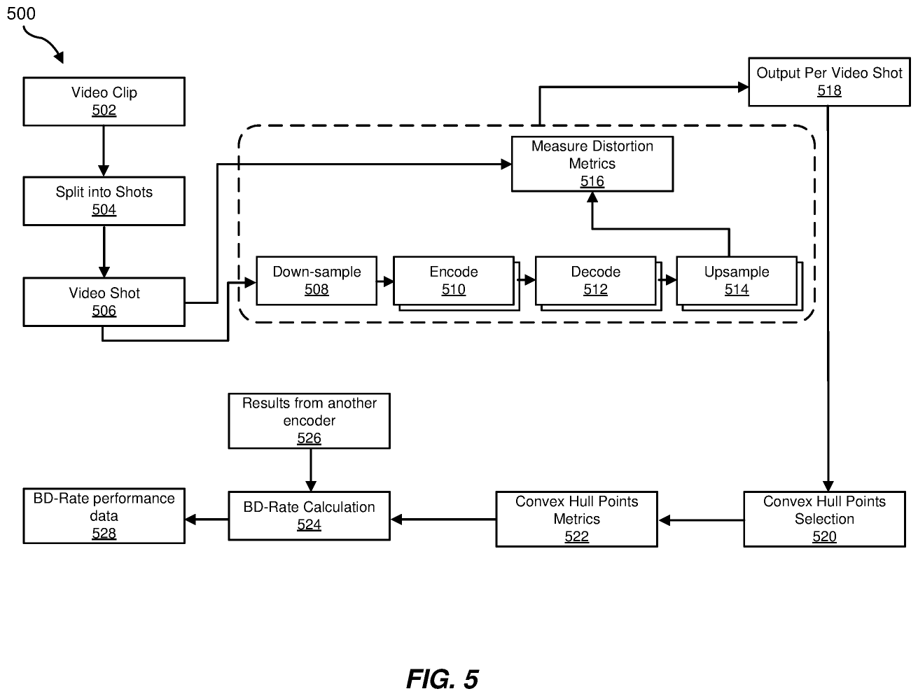

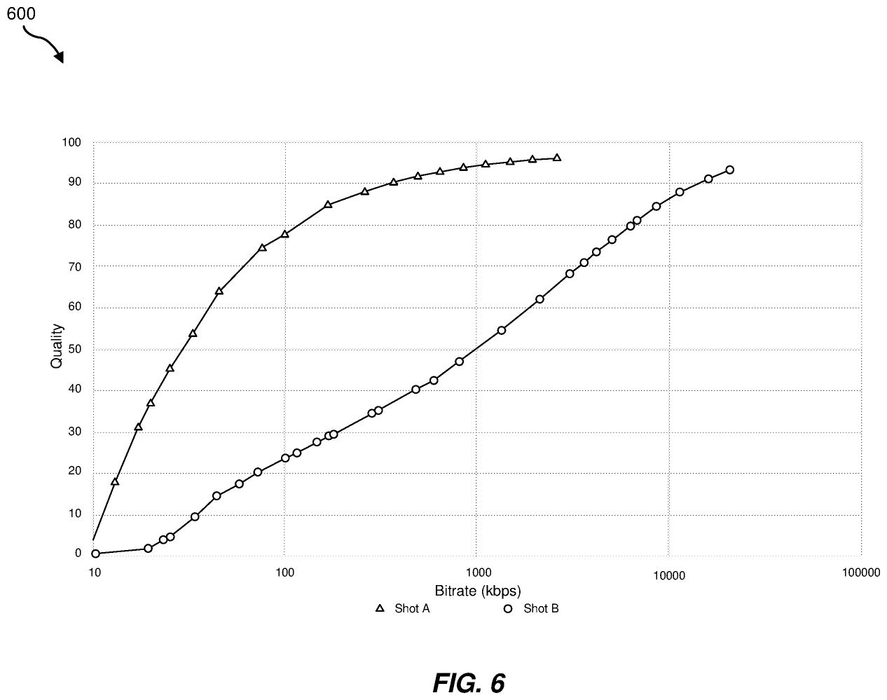

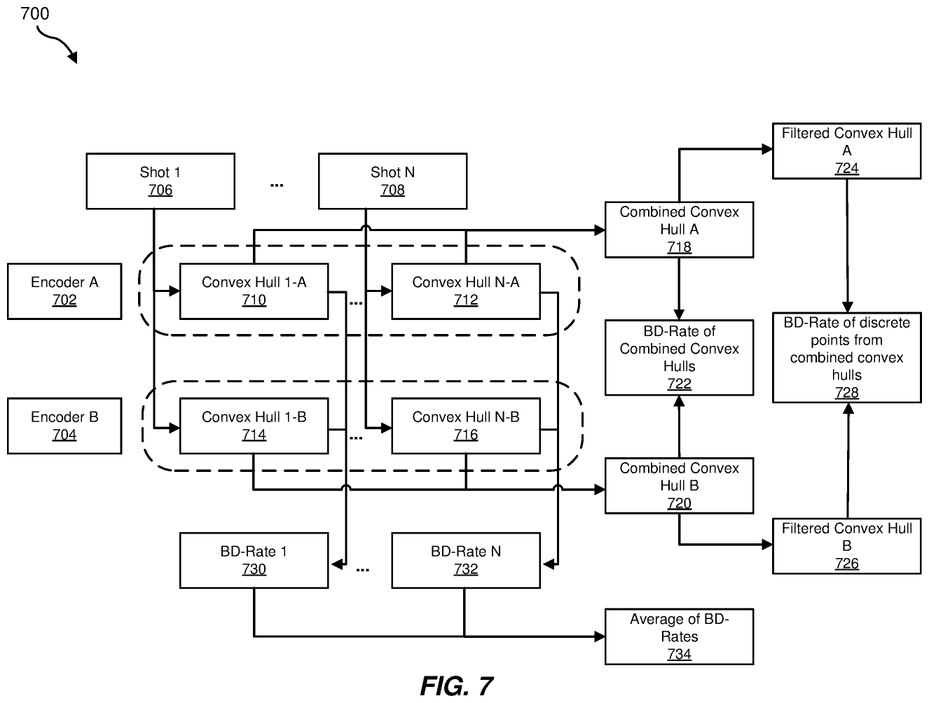

The following will provide, with reference to FIGS. 1-7, detailed descriptions of systems and methods for combined convex hull optimization for video encoding. Detailed descriptions of an exemplary process for combined convex hull optimization are provided in connection with FIG. 1. FIG. 2 illustrates an exemplary system for combined convex hull optimization. FIG. 3 illustrates an exemplary network environment for combined convex hull optimization. FIG. 4 illustrates a graph depicting a convex hull for video encoding. FIG. 5 illustrates an exemplary process for predicting encoding parameters for convex hull video encoding. FIG. 6 illustrates a graph of convex hulls for two different shots. FIG. 7 illustrates an exemplary workflow for combined convex hull optimization.

FIG. 1 is a flow diagram of an exemplary computer-implemented method 100 for combined convex hull optimization. The steps shown in FIG. 1 may be performed by any suitable computer-executable code and/or computing system, including the system(s) illustrated in FIGS. 2 and/or 3. In one example, each of the steps shown in FIG. 1 may represent an algorithm whose structure includes and/or is represented by multiple sub-steps, examples of which will be provided in greater detail below.

As illustrated in FIG. 1, at step 102 one or more of the systems described herein may combine a first video sequence with a second video sequence to generate a combined video sequence. For example, video sequence module 204 may combine first video sequence 222 with second video sequence 224 to generate combined video sequence 226. A video complexity of first video sequence 222 may differ from a video complexity of second video sequence 224.

In some embodiments, the term “video complexity” may refer to an amount of motion in a video sequence. For example, a video sequence including a static scene (e.g., having objects exhibiting little to no motion) may have less video complexity than a video sequence of a fast-moving scene (e.g., having one or more objects exhibiting motion). First video sequence 222 may have a higher or lower video complexity than second video sequence 224. In other words, first video sequence 222 may not have a similar video complexity as second video sequence 224. In some examples, video complexity may be determined based on motion estimation (“ME”). In some examples, video complexity may correspond to or otherwise be based on encoding complexity that may be represented by spatial complexity (e.g., videos having more details may have higher complexity than videos having fewer details).

Various systems described herein may perform step 110. FIG. 2 is a block diagram of an example system 200 for combined convex hull optimization. As illustrated in this figure, example system 200 may include one or more modules 202 for performing one or more tasks. As will be explained in greater detail herein, modules 202 may include a video sequence module 204, an optimization module 206, an analysis module 208, and a bitrate ladder module 210. Although illustrated as separate elements, one or more of modules 202 in FIG. 2 may represent portions of a single module or application.

In certain embodiments, one or more of modules 202 in FIG. 2 may represent one or more software applications or programs that, when executed by a computing device, may cause the computing device to perform one or more tasks. For example, and as will be described in greater detail below, one or more of modules 202 may represent modules stored and configured to run on one or more computing devices, such as the devices illustrated in FIG. 3 (e.g., computing device 302 and/or server 306). One or more of modules 202 in FIG. 2 may also represent all or portions of one or more special-purpose computers configured to perform one or more tasks.

As illustrated in FIG. 2, example system 200 may also include one or more memory devices, such as memory 240. Memory 240 generally represents any type or form of volatile or non-volatile storage device or medium capable of storing data and/or computer-readable instructions. In one example, memory 240 may store, load, and/or maintain one or more of modules 202. Examples of memory 240 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 2, example system 200 may also include one or more physical processors, such as physical processor 230. Physical processor 230 generally represents any type or form of hardware-implemented processing unit capable of interpreting and/or executing computer-readable instructions. In one example, physical processor 230 may access and/or modify one or more of modules 202 stored in memory 240. Additionally or alternatively, physical processor 230 may execute one or more of modules 202 to facilitate maintain the mapping system. Examples of physical processor 230 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

As illustrated in FIG. 2, example system 200 may also include one or more additional elements 220, such as first video sequence 222, second video sequence 224, a combined video sequence 226, a baseline performance curve 228, a target performance curve 232, and a bitrate ladder 234. One or more of additional elements 220 may be stored on a local storage device, such as memory 240, or may be accessed remotely. First video sequence 222 may represent a video sequence, as will be explained further below. Second video sequence 224 may represent another video sequence, having a different video complexity than first video sequence 222, as described herein. Combined video sequence 226 may represent a combination of video sequences, as will be explained further below. Baseline performance curve 228 may represent analysis of a performance of a baseline encoder, as will be explained further below. Target performance curve 232 may represent analysis of a performance of a target encoder, as will be explained further below. Bitrate ladder 234 may represent a bitrate ladder determined from analysis, as will be explained further below.

Example system 200 in FIG. 2 may be implemented in a variety of ways. For example, all or a portion of example system 200 may represent portions of example network environment 300 in FIG. 3.

FIG. 3 illustrates an exemplary network environment 300 implementing aspects of the present disclosure. The network environment 300 includes computing device 302, a network 304, and server 306. Computing device 302 may be a client device or user device, such as a mobile device, a desktop computer, laptop computer, tablet device, smartphone, or other computing device. Computing device 302 may include a physical processor 230, which may be one or more processors, memory 240, which may store data such as one or more of additional elements 220.

Server 306 may represent or include one or more servers capable of performing combined convex hull optimization. Server 306 may be a content server or other web server and may include one or more servers. Server 306 may include a physical processor 230, which may include one or more processors, memory 240, which may store modules 202, and one or more of additional elements 220.

Computing device 302 may be communicatively coupled to server 306 through network 304. Network 304 may represent any type or form of communication network, such as the Internet, and may comprise one or more physical connections, such as LAN, and/or wireless connections, such as WAN.

The systems described herein may perform step 102 in a variety of ways. In one example, video sequence module 204 may append second video sequence 224 to the end of first video sequence 222 to generate combined video sequence 226. Alternatively, video sequence module 204 may append first video sequence 222 to the end of second video sequence 224 to generate combined video sequence 226. In some examples, the order of appending first video sequence 222 and second video sequence 224 may be based on video complexity (e.g., increasing or decreasing video complexity). In some examples, the order of appending may be random or otherwise not specifically related to video complexity.

In some examples, video sequence module 204 may, rather than appending video sequences to create a new file, symbolically concatenate or otherwise combine first video sequence 222 and second video sequence 224. For example, similar to how a filesystem may maintain a symbolic link to a file's physical storage location, video sequence module 204 may maintain a symbolic link between first video sequence 222 and second video sequence 224 such that combined video sequence 226 may include symbolic links to first video sequence 222 and/or second video sequence 224.

At step 104 one or more of the systems described herein may perform, using a baseline encoder, encoding parameter optimization on the combined video sequence to generate a baseline performance curve. For example, optimization module 206 may perform, using the baseline encoder, encoding parameter optimization on combined video sequence 226 to generate baseline performance curve 228. Baseline performance curve 228 may correspond to a rate-distortion (“RD”) curve (as will be described further below) for combined video sequence 226 using the baseline encoder.

In some embodiments, the term “encoding parameter optimization” may refer to performing analysis to determine encoding parameters for one or more encoding schemes. In some embodiments, the determined encoding parameters may be optimal or near-optimal for one or more encoders that may balance a quality of encoded video produced with computational resources required for the encoding. Examples of encoding parameters include, without limitation, quantization parameter (QP) and resolutions. The QP may correspond to bitrate or other sampling metric and may further correlate to computational complexity.

The systems described herein may perform step 104 in a variety of ways. In one example, the encoding parameter optimization may correspond to convex hull optimization. A convex hull may correspond to performance boundaries for bitrates with respect to encoding parameters.

In some embodiments, the term “convex hull” may refer to the smallest convex set containing a set of points. For example, optimization module 206 may analyze combined video sequence 226 on a quality-bitrate plane (e.g., along a RD curve) as seen in graph 400 in FIG. 4. The quality may be measured using performance metrics such as Peak-Signal-to-Noise-Ratio (“PSNR”), Structural Similarity Index (SSIM), and Video Multimethod Assessment Fusion (“VMAF”). As seen in FIG. 4, for a given resolution, increasing the bitrate may increase quality until reaching diminishing returns or a plateau. However, each resolution may include a bitrate region which outperforms (e.g. exhibits higher quality than) other resolutions at that bitrate region. The convex hull may include these bitrate regions for the various resolutions as illustrated in FIG. 4. Thus, the convex hull may correspond to performance boundaries for bitrates for various resolutions.

Although convex hull optimization is described herein (and further described with respect to FIG. 5 below), in other embodiments optimization module 206 may use other encoding parameter analysis schemes and/or combinations thereof.

Returning to FIG. 1, at step 106 one or more of the systems described herein may perform, using a target encoder, encoding parameter optimization on the combined video sequence to generate a target performance curve. For example, optimization module 206 may perform, using the target encoder, encoding parameter optimization on combined video sequence 226 to generate target performance curve 232. Target performance curve 232 may correspond to an RD curve for combined video sequence 226 using the target encoder.

In some examples, a computational complexity of the target encoder may be greater than a computational complexity of the baseline encoder. The target encoder may correspond to a desired encoder for producing production videos (e.g., videos to be delivered to clients) and the baseline encoder may correspond to an encoder configured for analysis. For instance, the baseline encoder may be a faster encoder than the target encoder such that encoding with the baseline encoder may generally take less time and/or computing resources than using the target encoder. The baseline encoder may be an older generation encoder or may be a similar generation and/or same encoder as the target encoder with reduced performance settings. For example, the baseline encoder and the target encoder may correspond to two different presets of the same encoder or to two encoders that support different coding standards. In some examples, the baseline encoder (e.g., fast encoder) may be a fast hardware encoder implementation.

The systems described herein may perform step 106 in a variety of ways. In one example, optimization module 206 may perform convex hull optimization, as described herein. In other examples, optimization module 206 may utilize other encoding parameter analysis schemes and/or combinations thereof.

In some examples, performing, using the target encoder, encoding parameter optimization on the combined video sequence may further include using encoding parameters determined from performing, using the baseline encoder, encoding parameter optimization on the combined video sequence. The convex hull representing the optimal encoding parameters may be relatively the same for the baseline encoder and the target encoder, regardless of the encoder presets used in generating the convex hull for the shot. Thus, encoding parameters determined in step 104 may be used.

In some examples, generating the target performance curve further comprises filtering for performance values corresponding to production quality, which may correspond to a restricted discrete convex hull approach. For instance, filtering for performance values corresponding to production quality may include filtering out performance values below a minimum quality threshold. Below the minimum quality threshold, the video quality may be too poor to be reasonably viewed by users. The minimum quality threshold may be a predetermined number (e.g., 30 on a VMAF scale), and/or may be automatically and/or dynamically set through further quality analysis.

Filtering for performance values corresponding to production quality may also include filtering out performance values above a maximum quality threshold. Above the maximum quality threshold, the encoding complexity may exhibit diminishing returns in that users may not notice or appreciate the increased quality above the maximum quality threshold. The maximum quality threshold may be predetermined (e.g., 95 on the VMAF scale), and/or may be automatically and/or dynamically set through further quality analysis. Thus, target performance curve 232 and/or baseline performance curve 228 may be filtered for performance values corresponding to production quality as described herein.

Alternatively and/or in addition, filtering for performance valued corresponding to production quality may further include selecting discrete points, such as discrete points within the minimum and maximum quality thresholds which may further be spaced apart. For example, in reference to VMAF of [30, 95] and uniformly covering this range using generally even spacing of 10, eight operation points may be selected, namely VMAF values: 30, 40, 50, 60, 70, 80, 90, and 95. In other examples, other values may be selected based on other criteria.

At step 108 one or more of the systems described herein may analyze the target encoder by comparing the target performance curve with the baseline performance curve. For example, analysis module 208 may compare target performance curve 232 with baseline performance curve 228 to analyze the target encoder.

The systems described herein may perform step 108 in a variety of ways. In one example, target performance curve 232 (e.g., convex hull points therein) may be compared with baseline performance curve 228 (e.g., convex hull points therein) based on a Bjontegaard rate difference (“BD rate”). The BD rate may allow measurement of bitrate difference offered by a codec while maintaining a same quality as objectively measured and may be based on computing an average percent difference in rate over a range of qualities. In other examples, other performance analysis schemes may be used to compare performance between the target encoder and the baseline encoder.

At step 110 one or more of the systems described herein may generate a bitrate ladder for the target encoder based on the analysis. For example, bitrate ladder module 210 may generate bitrate ladder 234 for the target encoder based on the analysis performed at step 108. Bitrate ladder 234 may include desired bitrate-resolution pairs for encoding using the target encoder.

In some embodiments, the term “bitrate ladder” may refer to bitrate-resolution pairs for encoding. Each step of the bitrate ladder may correspond to a given quality/bitrate for an input video. A number of steps in a bitrate ladder may be a system parameter that may be optimized or otherwise adjusted based on one or more factors, including an amount of storage required, edge cache efficiency for streaming, and perceptibility of different representation of the same video content to the human eye.

The systems described herein may perform step 110 in a variety of ways. In one example, the analysis (e.g., BD rate) may be used to determine an appropriate and/or optimal bitrate ladder 234 for the target encoder, for example by minimizing BD-rate loss and/or maintaining the BD-rate loss below a quality loss threshold (e.g., 1.5%). The combined convex hull approach corresponding to method 100 (which may further include a restricted discrete convex hull approach), may provide a more accurate analysis than an alternative DO approach shown in FIG. 5, wherein each video sequence may be independently analyzed and optimized.

FIG. 5 illustrates a workflow 500 of encoding parameter optimization, that may correspond to the alternative DO approach for example using a target encoder. Given an input video clip at 502, the video clip may be split and/or organized into shots at 504 based on class (e.g., spatial resolution such as 1920×1080 or 1280×720) for analysis purposes, resulting in one or more video shots at 506.

Each video shot may be downsampled at 508, for example one or more lower resolutions than an original resolution. The downsampled shots may be encoded at 510, which may include encoding using one or more encoders. The encoded shots may be decoded at 512 and upsampled at 514 to the original resolution. The upsampled shots may be analyzed by comparing to the original shot, for example by measuring distortion or performance metrics at 516. The metrics may include, for instance, PSNR, SSIM, and VMAF. The performance metrics may be output per video shot at 518 for convex hull points selection (e.g., using convex hull optimization) at 520.

The selected convex hull points may be measured for convex hull points metrics (e.g., PSNR, SSIM, VMAF) at 522 for BD-rate calculation at 524. The BD-rate calculation may further include results from another encoder (e.g., a baseline encoder) at 526. The BD-rate calculation may generate BD-rate performance data at 528, which may be used for determining a bitrate ladder or other evaluation of the target encoder.

The BD-rate performance data may be averaged across the different classes of video for video standardization to determine a global measure of performance. Although such an averaging may produce a usable metric, using the same encoding parameters for a variety of video may result in cases where the qualities/bitrates may be unreasonably high (e.g., a 1080p sequence resulting in a 100 Mbps bitrate) and/or unreasonably low (e.g., the same 1080p sequence encoded at 80 kbps).

FIG. 6 illustrates a graph 600 of convex hulls for Shot A (e.g., a generally static shot having low video complexity) and Shot B (e.g., a high motion shot having high video complexity). As seen in FIG. 6, the higher video complexity Shot B has a different convex hull shape than that of Shot A. Thus, averaging BD rates obtained from these convex hulls may not properly account for the lower performance due to the video complexity of Shot B.

FIG. 7 illustrates a workflow 700 corresponding to various approaches, including the alternate DO approach (e.g., FIG. 5) and a combined convex hull approach (e.g., method 100), including a restricted discrete combined convex hull approach (e.g., method 100). As described herein, an encoder A 702 (e.g., baseline encoder) may be compared with an encoder B 704 (e.g., target encoder), using various shots, including shot 1 706 to shot N 708.

In the alternate DO approach, each shot may be analyzed (e.g., by downsampling, encoding, decoding, upsampling, and measuring performance as described herein) independently. Thus, shot 1 706 may be analyzed using encoder A 702 for convex hull 1-A 710 and analyzed using encoder B 704 for convex hull 1-B 714, the results of which may be compared for BD-rate 1 730. Similarly, shot N 708 may be analyzed using encoder A 702 for convex hull N-A 712 and analyzed using encoder B 704 for convex hull N-B 716, the results of which may be compared for BD-rate N 732. BD-rate 1 730 and BD-rate N 732 may be combined (e.g., averaged) into an average of BD-rates 734 as described above.

In the combined convex hull approach, for a given codec the convex hulls for every shot (e.g., convex hull 1-A 710 and convex hull N-A 712 for encoder A 702, and convex hull 1-B 714 and convex hull N-B 716 for encoder B 704) may be combined into a single convex hull. Thus, convex hull 1-A 710 to convex hull N-A 712 (for shots 1 706 to shot N 708) may be combined into combined convex hull A 718 as described herein. Similarly, convex hull 1-B 714 to convex hull N-B 716 may be combined into combined convex hull B 720 as described herein. BD-rate of combined convex hulls 722 may be determined from combined convex hull A 718 and combined convex hull B 720 as described herein.

The restricted discrete combined convex hull approach may further refine the combined convex hull approach described above. Combined convex hull A 718 may be filtered (e.g., based on VMAF from 30-95 as described herein) and combined convex hull B 720 may be filtered (e.g., based on VMAF from 30-85 as described herein). BD-rate of discrete points from combined convex hulls 728 may be determined from filtered convex hull A 724 and filtered convex hull B 726 as describe herein. Thus, the restricted discrete combined convex hull approach may cover qualities deployed in adaptive bitrate streaming via the filtered discrete points.

In reference to the systems and methods described herein, the present disclosure provides improved video encoding optimization. Adaptive video streaming requires multiple encoded versions of a source video to allow selecting an appropriate version based on network conditions. A dynamic optimizer framework may apply convex hull encoding to efficiently determine optimal encoding parameters for a given video sequence using a given encoder. To evaluate the encoder, the encoder may be applied to various video sequences, the encoder's performance may be measured for each video sequence, and the encoder's performance values may be averaged. However, such an average may not properly account for the different complexities of the video sequences (e.g., good performance for a simple video may mask poor performance for a complex video). To address these issues, the systems and methods described herein provide a combined convex hull approach. After combining the video sequences into a combined sequence and applying the dynamic optimizer, the resultant performance values may be combined into a single performance curve to be compared with another encoder's performance curve. To further refine the performance curve for evaluation, values at the extremes (e.g., very low quality and very high quality) may be filtered out because in a practical video service, very low quality and very high-quality videos may not be used. The results of the evaluation may be used to generate an appropriate bitrate ladder that enumerates quality/bitrate values for encoding an input video.

### EXAMPLE EMBODIMENTS

Example 1: A computer-implemented method for combined convex hull optimization may include (i) combining a first video sequence with a second video sequence to generate a combined video sequence, wherein a video complexity of the first video sequence differs from a video complexity of the second video sequence, (ii) performing, using a baseline encoder, encoding parameter optimization on the combined video sequence to generate a baseline performance curve, (iii) performing, using a target encoder, encoding parameter optimization on the combined video sequence to generate a target performance curve, (iv) analyzing the target encoder by comparing the target performance curve with the baseline performance curve, and (v) generating a bitrate ladder for the target encoder based on the analysis, wherein the bitrate ladder includes desired bitrate-resolution pairs for encoding.

Example 2: The method of Example 1, wherein generating the target performance curve further comprises filtering for performance values corresponding to production quality.

Example 3: The method of Example 2, wherein filtering for performance values corresponding to production quality further comprises filtering out performance values below a minimum quality threshold.

Example 4: The method of Example 2 or 3, wherein filtering for performance values corresponding to production quality further comprises filtering out performance values above a maximum quality threshold.

Example 5: The method of any of Examples 1-4, wherein the encoding parameter optimization corresponds to convex hull optimization and a convex hull corresponds to performance boundaries for bitrates with respect to encoding parameters.

Example 6: The method of any of Examples 1-5, wherein performing, using the target encoder, encoding parameter optimization on the combined video sequence further comprises using encoding parameters determined from performing, using the baseline encoder, encoding parameter optimization on the combined video sequence.

Example 7: The method of any of Examples 1-6, wherein a computational complexity of the target encoder is greater than a computational complexity of the baseline encoder.

Example 8: A system comprising: at least one physical processor, and physical memory comprising computer-executable instructions that, when executed by the physical processor, cause the physical processor to: (i) combine a first video sequence with a second video sequence to generate a combined video sequence, wherein a video complexity of the first video sequence differs from a video complexity of the second video sequence, (ii) perform, using a baseline encoder, encoding parameter optimization on the combined video sequence to generate a baseline performance curve, (iii) perform, using a target encoder, encoding parameter optimization on the combined video sequence to generate a target performance curve, (iv) analyze the target encoder by comparing the target performance curve with the baseline performance curve, and (v) generate a bitrate ladder for the target encoder based on the analysis, wherein the bitrate ladder includes desired bitrate-resolution pairs for encoding.

Example 9: The system of Example 8, wherein generating the target performance curve further comprises filtering for performance values corresponding to production quality.

Example 10: The system of Example 9, wherein filtering for performance values corresponding to production quality further comprises filtering out performance values below a minimum quality threshold.

Example 11: The system of Example 9 or 10, wherein filtering for performance values corresponding to production quality further comprises filtering out performance values above a maximum quality threshold.

Example 12: The system of any of Examples 8-11, wherein the encoding parameter optimization corresponds to convex hull optimization and a convex hull corresponds to performance boundaries for bitrates with respect to encoding parameters.

Example 13: The system of any of Examples 8-12, wherein performing, using the target encoder, encoding parameter optimization on the combined video sequence further comprises using encoding parameters determined from performing, using the baseline encoder, encoding parameter optimization on the combined video sequence.

Example 14: The system of any of Examples 8-13, wherein a computational complexity of the target encoder is greater than a computational complexity of the baseline encoder.

Example 15: A non-transitory computer-readable medium comprising one or more computer-executable instructions that, when executed by at least one processor of a computing device, cause the computing device to: (i) combine a first video sequence with a second video sequence to generate a combined video sequence, wherein a video complexity of the first video sequence differs from a video complexity of the second video sequence, (ii) perform, using a baseline encoder, encoding parameter optimization on the combined video sequence to generate a baseline performance curve, (iii) perform, using a target encoder, encoding parameter optimization on the combined video sequence to generate a target performance curve, (iv) analyze the target encoder by comparing the target performance curve with the baseline performance curve, and (v) generate a bitrate ladder for the target encoder based on the analysis, wherein the bitrate ladder includes desired bitrate-resolution pairs for encoding.

Example 16: The non-transitory computer-readable medium of Example 15, wherein generating the target performance curve further comprises filtering for performance values corresponding to production quality.

Example 17: The non-transitory computer-readable medium of Example 16, wherein filtering for performance values corresponding to production quality further comprises filtering out performance values below a minimum quality threshold and filtering out performance values above a maximum quality threshold.

Example 18: The non-transitory computer-readable medium of any of Examples 15-17, wherein the encoding parameter optimization corresponds to convex hull optimization and a convex hull corresponds to performance boundaries for bitrates with respect to encoding parameters.

Example 19: The non-transitory computer-readable medium of any of Examples 15-18, wherein performing, using the target encoder, encoding parameter optimization on the combined video sequence further comprises using encoding parameters determined from performing, using the baseline encoder, encoding parameter optimization on the combined video sequence.

Example 20: The non-transitory computer-readable medium of any of Examples 15-19, wherein a computational complexity of the target encoder is greater than a computational complexity of the baseline encoder.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive video data to be transformed, transform the video data, output a result of the transformation to measure performance of an encoder, use the result of the transformation to analyze the encoder, and store the result of the transformation to determine a bitrate ladder for the encoder. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
combining a first video sequence with a second video sequence to generate a combined video sequence, wherein a video complexity of the first video sequence differs from a video complexity of the second video sequence;
performing, using a baseline encoder, encoding parameter optimization on the combined video sequence to generate a baseline performance curve;
performing, using a target encoder, encoding parameter optimization on the combined video sequence to generate a target performance curve;
analyzing the target encoder by comparing the target performance curve with the baseline performance curve; and
generating a bitrate ladder for the target encoder based on the analysis, wherein the bitrate ladder includes desired bitrate-resolution pairs for encoding.

2. The method of claim 1, wherein generating the target performance curve further comprises filtering for performance values corresponding to production quality.

3. The method of claim 2, wherein filtering for performance values corresponding to production quality further comprises filtering out performance values below a minimum quality threshold.

4. The method of claim 2, wherein filtering for performance values corresponding to production quality further comprises filtering out performance values above a maximum quality threshold.

5. The method of claim 1, wherein the encoding parameter optimization corresponds to convex hull optimization and a convex hull corresponds to performance boundaries for bitrates with respect to encoding parameters.

6. The method of claim 1, wherein performing, using the target encoder, encoding parameter optimization on the combined video sequence further comprises using encoding parameters determined from performing, using the baseline encoder, encoding parameter optimization on the combined video sequence.

7. The method of claim 1, wherein a computational complexity of the target encoder is greater than a computational complexity of the baseline encoder.

8. A system comprising:
at least one physical processor; and
physical memory comprising computer-executable instructions that, when executed by the physical processor, cause the physical processor to:
combine a first video sequence with a second video sequence to generate a combined video sequence, wherein a video complexity of the first video sequence differs from a video complexity of the second video sequence;
perform, using a baseline encoder, encoding parameter optimization on the combined video sequence to generate a baseline performance curve;
perform, using a target encoder, encoding parameter optimization on the combined video sequence to generate a target performance curve;
analyze the target encoder by comparing the target performance curve with the baseline performance curve; and
generate a bitrate ladder for the target encoder based on the analysis, wherein the bitrate ladder includes desired bitrate-resolution pairs for encoding.

9. The system of claim 8, wherein generating the target performance curve further comprises filtering for performance values corresponding to production quality.

10. The system of claim 9, wherein filtering for performance values corresponding to production quality further comprises filtering out performance values below a minimum quality threshold.

11. The system of claim 9, wherein filtering for performance values corresponding to production quality further comprises filtering out performance values above a maximum quality threshold.

12. The system of claim 8, wherein the encoding parameter optimization corresponds to convex hull optimization and a convex hull corresponds to performance boundaries for bitrates with respect to encoding parameters.

13. The system of claim 8, wherein performing, using the target encoder, encoding parameter optimization on the combined video sequence further comprises using encoding parameters determined from performing, using the baseline encoder, encoding parameter optimization on the combined video sequence.

14. The system of claim 8, wherein a computational complexity of the target encoder is greater than a computational complexity of the baseline encoder.

15. A non-transitory computer-readable medium comprising one or more computer-executable instructions that, when executed by at least one processor of a computing device, cause the computing device to:
combine a first video sequence with a second video sequence to generate a combined video sequence, wherein a video complexity of the first video sequence differs from a video complexity of the second video sequence;
perform, using a baseline encoder, encoding parameter optimization on the combined video sequence to generate a baseline performance curve;
perform, using a target encoder, encoding parameter optimization on the combined video sequence to generate a target performance curve;
analyze the target encoder by comparing the target performance curve with the baseline performance curve; and
generate a bitrate ladder for the target encoder based on the analysis, wherein the bitrate ladder includes desired bitrate-resolution pairs for encoding.

16. The non-transitory computer-readable medium of claim 15, wherein generating the target performance curve further comprises filtering for performance values corresponding to production quality.

17. The non-transitory computer-readable medium of claim 16, wherein filtering for performance values corresponding to production quality further comprises filtering out performance values below a minimum quality threshold and filtering out performance values above a maximum quality threshold.

18. The non-transitory computer-readable medium of claim 15, wherein the encoding parameter optimization corresponds to convex hull optimization and a convex hull corresponds to performance boundaries for bitrates with respect to encoding parameters.

19. The non-transitory computer-readable medium of claim 15, wherein performing, using the target encoder, encoding parameter optimization on the combined video sequence further comprises using encoding parameters determined from performing, using the baseline encoder, encoding parameter optimization on the combined video sequence.

20. The non-transitory computer-readable medium of claim 15, wherein a computational complexity of the target encoder is greater than a computational complexity of the baseline encoder.
